(19) United States
(12) Patent Application Publication
(10) Pub. No.: US 2004/0199406 A1
(43) Pub. Date: Oct. 7, 2004

(54) System for monitoring payment for provision of services to an entity

(76) Inventors: Raymond Owens, King of Prussia, PA (US); Douglas J. Cole, Valley Forge, PA (US); Stephen Lozowski, West Chester, PA (US); Nicholas Conti, Spring City, PA (US); Mike Digiacomo, Douglasville, PA (US)

Correspondence Address: Alexander J. Burke, Intellectual Property Department, 5th Floor, 170 Wood Avenue South, Iselin, NJ, 08830, US

(21) Appl. No.: 10/773,544

(22) Filed: Feb. 6, 2004

Related U.S. Application Data
(60) Provisional application No. 60/452,861, filed on Mar. 7, 2003.

(51) Int. Cl. G06F 17/60

(52) U.S. Cl. 705/2

(57) ABSTRACT

A system for grouping records of charges associated with provision of services to an entity to support reimbursement monitoring includes an acquisition processor for acquiring data related to charges for services provided to the entity. A data processor is coupled to the acquisition processor and to a source of rules. The data processor groups the charges using the rules to provide a reimbursable amount value and creates a record containing data representing the grouped charges and the reimbursable amount value.

The present application is based on Provisional application no. 60/452,861, filed on March 7, 2003.

### FIELD OF THE INVENTION

The present invention relates generally to the field of accounting systems, and more particularly to a system for monitoring charges and payments for services rendered to an entity.

### BACKGROUND OF THE INVENTION

The present application deals with monitoring and collecting charges made for rendering services to an entity. For example, such a system may monitor charges and payments for medical or other healthcare services provided to a patient. A charge is a dollar amount associated with such a performed service. These charges are paid by a payer, such as an insurance company, and/or by a guarantor, who is a person who has promised to pay any charges not paid by a payer. One or more charges may be allocated to a receivable. A receivable is the smallest unit of debt for which the provider of the service may expect payment from either a payer or guarantor and from which the provider may calculate payment discrepancies. There are three types of receivables: claim level, claim line level, and charge level, explained in more detail below. This categorization reflects how the payer remits and how the provider wishes to post the remittance.

Existing healthcare accounting systems categorize receivables into an account or file for producing a claim (for a payer) or invoice (for a guarantor). Accounts are established and maintained by the accounting system and do not necessarily correlate directly or simply to patients, medical procedures performed for the patients and/or payer reimbursement plans. To associate charges with the appropriate account or file an administrative person makes an accounting or billing decision before establishing the clinical summary of the data. Given the complexity of billing and reimbursement rules, these individuals often do not have the knowledge and resources to accurately achieve the correct results.

Some accounting systems interfaced to existing patient accounting systems require that the proper account within the patient accounting system be identified for each transaction sent to that system. Other accounting systems include logic to automatically create accounts based on the type of patient interaction and to subsequently place charges for those visits into their associated account. In such systems, a system user may post payments to individual charges, but the user cannot group charges into receivables except at the level of that account. Further, in such systems, knowledge of the structure of existing patient accounting systems and conventions is required of patient management and clinical personnel who are required to perform accounting related tasks. The complex and non-intuitive nature of such systems is perceived as an obstacle to efficient job performance and is a source of worker dissatisfaction. Charges are often placed in the wrong account as a result of the limited knowledge of billing requirements possessed by non-financial personnel.

Many systems focus on, and are limited by, the concept of an account identifier, such as an account number. Some systems require the use of a special code or function to change an account from, for example, an outpatient to an inpatient account in order to generate the proper invoice. Patient management and clinical systems are required to communicate with the patient accounting system by means of the account number, and this places a burden on users to have continuous access to the correct account number. Changes to billing requirements may cause significant changes and disruptions in such patient management and clinical systems.

Payments made by a responsible party in response to invoices can be scrutinized either at the account level or at the level of a specific individual charge. When a payer sends multiple payments regarding a single account, existing systems fail to determine if the payments received to date are the expected payments, or if further payments should be awaited before marking a billed receivable for investigation of a payment discrepancy.

Healthcare related data management systems exist which attempt to address the accounting issues described above. For example, data processing systems exist which process health insurance claims. However, these systems do not address the issue of the efficient creation and management of the data which forms the basis of such claim submissions. Other existing data processing systems address the issue of tracking receivables. However, such systems are limited to the problem of collecting unpaid receivables owed to insurance companies, and do not address the issue of efficiently managing accounting data which serves as the basis for claims submitted to an insurance company. There are also systems for billing an insurance company for medical services. Such systems generally are limited to the problem of defining and transmitting data codes to an insurer, or calculating reimbursement for a group of medical services, or combining records of services from multiple customer accounts, interactions, cases or visits into a single account.

While the known systems described above address various aspects of medical accounting problems, they suffer from a dependence on the concept of a patient account and the characteristics peculiar to the creation and management of that account according to a set of predetermined rules. The need exists for a system that can group receivables at the level of expected payment from different responsible parties and that can be used to perform billing and collections functions independently of or without the need for a patient account.

### BRIEF SUMMARY OF THE INVENTION

In accordance with principles of the present invention, a system for grouping records of charges associated with provision of services to an entity to support reimbursement monitoring includes an acquisition processor for acquiring data related to charges for services provided to the entity. A data processor is coupled to the acquisition processor and to a source of rules. The data processor groups the charges using the rules to provide a reimbursable amount value and creates a record containing data representing the grouped charges and the reimbursable amount value.

### BRIEF DESCRIPTION OF THE DRAWING

In the drawing:

FIG. 1 depicts a system for automatically creating receivables and for categorizing the receivables into groups for billing and collection in accordance with the principles of the present invention;

FIG. 2 depicts a static structural diagram of the receivable view shown in FIG. 1;

FIG. 3 is a flow chart showing the processing of receivables based on new charges introduced into the system depicted in FIG. 1;

FIG. 4 is a flow chart showing the process of identifying a candidate receivable group as depicted in FIG. 3;

FIG. 5 is a flow chart showing the processing of an insurance receivable subsequent to the identification of parameters defined within the receivable view depicted in FIG. 2;

FIG. 6 is a flow chart showing the effect of a change of the contract management result set on the receivables depicted in FIG. 2;

FIG. 7 is a pictorial depiction of a claim showing claim lines produced as the result of an inpatient encounter; and

FIG. 8 is a flow chart describing the default interim and serial billing receivable rules used by the system depicted in FIG. 1.

### DETAILED DESCRIPTION OF THE INVENTION

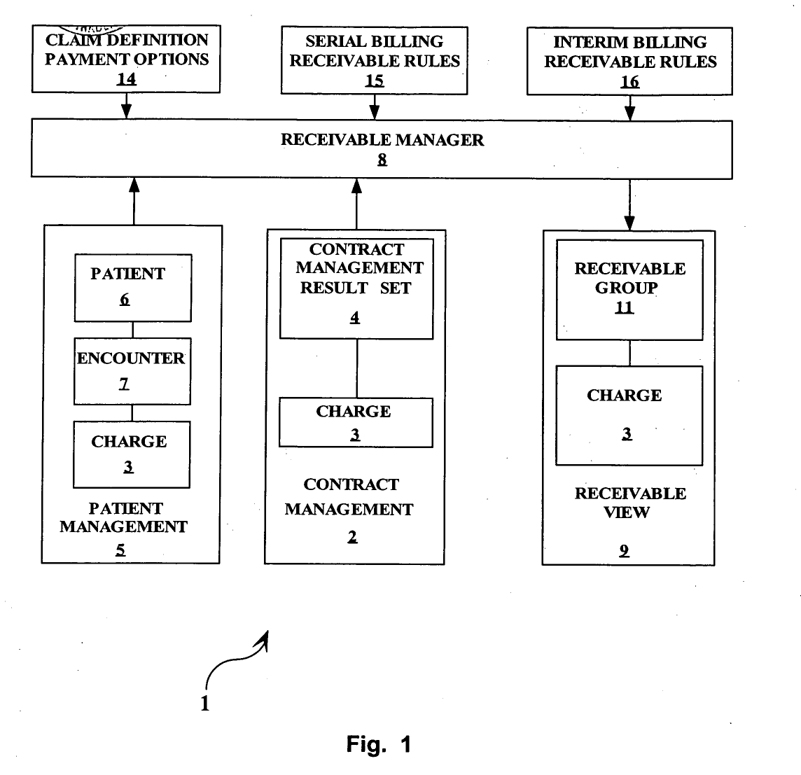

A glossary follows this detailed description which may be consulted for more complete definitions for terms used herein. Referring to FIG. 1, a healthcare payment monitoring system 1 is shown. The system 1 may be a separate software application or be an object or procedure of another larger software application. The system 1 may be executed as a program of instructions on a server, a personal computer or other computing device having a user interface.

The healthcare payment monitoring system 1 includes a contract management system 2. The contract management system 2 is an information system which calculates an expected reimbursement from payers for medical services performed by healthcare providers based on contracts between the providers and the payers. The contract typically defines the coverage that is provided for specific services as well as the obligations or duties of the patient or guarantor in order to obtain such coverage. Examples of typical patient/guarantor obligations include the payment of a deductible amount, the satisfaction of a co-payment, obtaining a second opinion for certain procedures, and/or notifying the payer prior to obtaining certain services or undergoing extraordinary procedures.

The contract management system 2 includes an acquisition processor for acquiring data related to charges 3 for healthcare encounters by a patient with a healthcare provider organization. The contract management system 2 also includes data representing the terms of the contract, as described above, and a processor which accesses this data when a system user submits data representing a medical service provided to a patient. The contract data is used to produce a set of rules which are used to process the acquired charge data 3. If the contract data indicates that the service is covered by the payer, the contract management system 2 calculates the expected payment that the healthcare provider receives for providing the service along with any financial obligation of the patient, based on the set of rules corresponding to the insurance contract. The charge 3 is the monetary amount associated with a performed service. While the amount of charge 3 may be manually entered in the contract management system 2, the amount is typically calculated automatically based on criteria contained in the definition of the service being performed, as described above.

A patient management system 5 is an information system used to manage the entrance and exit of patients 6 into and out of healthcare provider systems. Users of the patient management system 5 collect patient related information and supply it to the patient management system 5 to maintain the basic demographic, clinical and insurance information needed to provide clinical services and receive financial payment. This information is stored in mass storage devices associated with the patient management system 5, and a processor retrieves such information in response to queries by system users and/or other information systems. In the healthcare industry this is often referred to as an Admission, Discharge and Transfer (ADT) system.

When a patient 6 meets or interacts with one or more healthcare providers for the purpose of receiving one or more health related services, such a meeting or interaction is defined as an encounter 7. While most encounters 7 occur in person, they may also occur remotely, such as the case of a telephone call between a patient and a physician. The contract management system 2 calculates and creates a result set 4 that is a categorization or grouping of charges for one or more encounters 7 that are reimbursed as a unit by the primary responsible party. For instance, the result set 4 may include data representing charges for a consultation with a doctor, a laboratory test and an X-ray occurring in a single encounter 7.

A receivable manager 8 obtains charge data 3 as well as other information from both the patient management system 5 and the contract management system 2, and creates a receivable view 9 for use with billing and collections activities. The receivable view 9 contains data representing charges 3 related to provision of medical services in an encounter 7, or more than one encounter 7, which is grouped into a record termed a receivable group record 11. The data in the receivable group record 11 represents charges that are bundled together in order to satisfy payer billing requirements. Data representing charges related to the encounter(s) 7 is assembled in records representing receivables. Then data representing records representing related receivables are grouped into a record representing a receivable group 11. Thus, a receivable group record 11 includes data which represents a collection of receivable records.

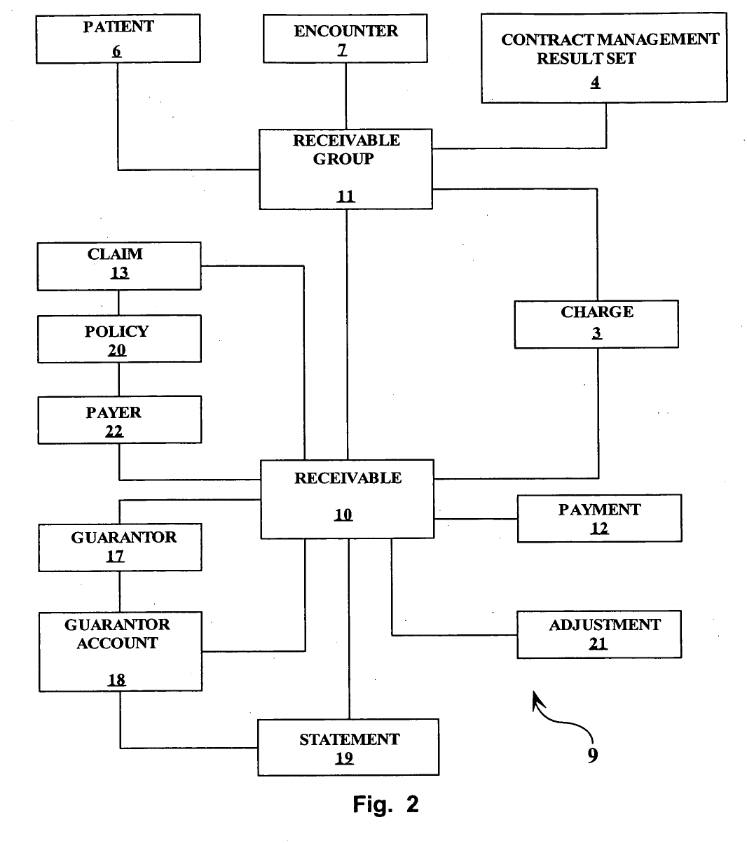

Receivable records form the basis for billing and collection, and represent the item for which the healthcare provider is attempting to obtain payment. In most cases healthcare providers do not bill each charge 3 individually and receive individual payments for each charge 3. A receivable record includes data which corresponds to the grouping of charges 3 that are both billed together and paid together based on an insurance policy 20, contract or course of dealing between the healthcare provider and the payer 22. Referring to FIG. 2, a receivable record 10 contains data representing the smallest unit of debt for which the healthcare provider can expect payment 12 and is used as a basis for calculating payment discrepancies.

A claim 13 is a request for a sum of money due for one or more services performed for a specific patient 6 or for related patients 6 (such as a mother and baby for birthing and natal care) between certain dates and corresponds to an invoice which is forwarded to the payer 22. The claim 13 informs the payer 22 of the services which were rendered in the encounter(s) regardless of whether payment is expected. As described above, there are three types or levels of insurance receivables, namely the claim level, the claim line level, and the charge level. A receivable at the claim level includes charges grouped together in a claim to be submitted to the payer 22. A receivable at the claim line level includes charges grouped together as a single item included along with other such items in a claim to be submitted to the payer 22. A receivable at the charge level is submitted in a separate claim to be submitted to the payer 22.

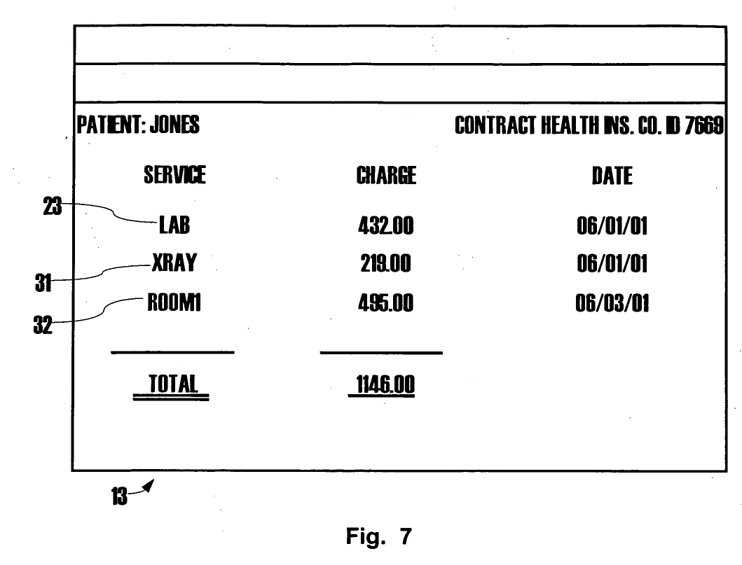

FIG. 7 is a textual representation of a claim 13 and may be used to illustrate the claim levels. In FIG. 7, the claim 13 is composed of one or more claim lines 23, 31, 32, for example, which are simply the individual reports (typically just a line or two in length) describing each service rendered. For example, the claim 13 for an inpatient hospital stay for a patient having bypass surgery would include individual claim lines referring to the use of the room (32), the radiology services (31), the laboratory services (23), the pharmacy services, the nursing services, the physical therapy, and any drugs that were used (not shown).

Referring again to FIG. 2, a receivable record 10 is associated with one receivable group record 11. The receivable group record 11 contains data representing charges 3 from one or more encounters 7, patients 6 and contract management result sets 4, grouped according to payer rules and healthcare provider preferences.

As described above, a responsible party is any person or organization responsible for paying at least some of the charges 3 resulting from an encounter 7. A responsible party may be either a payer 22 or a guarantor 17. The party having primary responsibility is the payer of first resort and is either the primary payer 22 in an insurance situation or the guarantor 17 in a self-pay situation. The responsible party having primary responsibility, e.g. payer 22, is used to determine which rules apply for creating a receivable group 11 record and for associating receivable 10 data with that receivable group 11 record.

One receivable 10 record is created for each applicable responsible party (17,22) associated with this encounter 7. Charges 3 resulting from the encounter 7 or over the applicable time period are allocated among the responsible parties (17,22) in accordance with the contract. Data representing the allocated portion of the charge 3 is entered into the receivable record 10 associated with that responsible party (17,22). That is, if 80% of a charge is to be paid by a payer 22 and 20% by the guarantor 17, charge data representing 80% of that charge is stored in the receivable record 10 associated with the payer 22, and charge data representing 20% of that charge is stored in the receivable record 10 associated with the guarantor 17. A record representing one receivable group 11 is created and contains data representing the receivable records 10 associated with the respective responsible parties for the charges 3 generated by a particular encounter 7 or over the applicable time period. Continuing the example, data representing both the payer 22 and guarantor 17 receivable records 10 is stored in a single receivable group 11 record.

Referring again to FIG. 1, payer rules may include claim definition/payment options 14, serial billing receivable rules 15 and/or interim billing receivable rules 16, described in more detail below. These rules may be provided by a payer organization to the healthcare provider, or may be derived by the healthcare provider in the absence of or as a substitute for rules received from the payer organization. Any of several methods of grouping charges may be used. For example, a payer may require that a healthcare provider (a) group together charges accruing within a predetermined time period (e.g. (i) a day, (ii) a week, (iii) a month, (iv) multiple months or (v) some other payer organization defined period) for multiple encounters of the patient with the healthcare provider, (b) group together charges accruing within an overall time period for a single encounter of the patient with the healthcare provider where, in this case, the single encounter is considered to have a duration of shorter time periods, (c) group together charges accruing in response to a single encounter of the patient with the healthcare provider, and/or (d) group together charges accruing in response to multiple encounters of the patient with the healthcare provider.

More specifically, serial billing is the practice of submitting outpatient insurance claims for ongoing and/or repetitive services that are rendered during many encounters over an extended period of time, such as weeks or months. Serial billing would be appropriate, for example, for physical therapy, dialysis and/or chemotherapy. If a treatment is ongoing, multiple periodic insurance claims 13 (FIG. 2) are generated. Each claim 13 is used to report services performed during multiple encounters that take place over a period of time. When serial billing rules 15 apply to outpatient treatments, charge data from multiple encounters 7 and contract management results sets 4 for a given time period, as described above, are preferably stored in one receivable group record 11. A payer 22 normally specifies which recurring service types need to be billed in a serial fashion. For example, a patient may require physical therapy sessions weekly for a year; and the payer 22 may require that these sessions to be billed monthly.

Interim billing (also termed periodic billing) is the practice of submitting insurance claims on a periodic basis while the patient 6 is still receiving care on an inpatient basis. A final claim is submitted after the patient is discharged. Long term inpatients such as burn and neo-natal cases are often billed in this manner. In some situations payers 22 require interim invoices to be submitted for long term inpatients, while in other situations it is an option for the healthcare provider or is not permitted. When interim billing rules 16 apply to inpatients, data representing charges 3 from one encounter 7 and/or one contract management result set 4 can be separated into multiple receivable group records 11, each representing a different time period.

When neither serial nor interim billing rules apply, data representing a charge 3 from a contract management result set 4 is stored in one receivable group record 11. This is also the default mode for self pay encounters where no third party payers exist. Charges for more than one encounter 7 may be associated with one contract management result set 4 in the contract management system 2. Also, charges for more than one patient 7 may be associated with the same contract management result set 4 within the contract management system 2, such as might occur in the case of a mother and a newborn child.

Each receivable record 10 (FIG. 2) includes data representing an expected reimbursement amount that is acquired from the contract management system 2, as well as a balance amount calculated by the system 1 (FIG. 1). Reimbursement is the monetary compensation that a healthcare provider receives from a payer 22 or guarantor 17 for providing care to a patient, and the balance amount is the amount of that reimbursement which remains unpaid. In healthcare accounting systems, reimbursement is either estimated (meaning that it has not yet been collected) or is actual (meaning that collection has already occurred). A receivable record 10 may be associated with a guarantor account 18, and the balance amount for that receivable record 10 may be billed to the guarantor 17 on statements 19. A receivable record 10 may also be associated with a payer 22, in which case the balance amount for that receivable record 10 is billed to the payer 22 via claims 13. Payments 12 and adjustments 21 can be posted to receivable records 10. That is, when an adjustment 21 is made, or a payment 12 is received from a payer 22 or a guarantor 17, the amount of the payment or adjustment may be used to adjust the balance amount data in the receivable record 10 with which that payment or adjustment is associated. A balance transfer may also be used to allocate money from one account receivable record 10 to another receivable record 10 within the same receivable group 11. In this case, the balance amount in the applicable receivable records 10 are adjusted by corresponding amounts. Conceptually, therefore, guarantor accounts 18, payments 12, adjustments 21, balance transfers, claims 13 and statements 19 are functions that can be applied to a receivable 10 in the present healthcare information system 1.

The receivable manager 8 (FIG. 1) includes a payment monitor which monitors payments received from responsible parties (17, 22) for the healthcare services provided to patients. In response to receiving data representing a payment 12 or adjustment 21, the payment monitor compares the balance amount data in the receivable record 10 to the payment 12 which has been received from the responsible party associated with that receivable record 10. The payment monitor in the receivable manager 8 then generates an indication that the received payment 12 or adjustment 21 matches the expected reimbursable amount in the receivable record, or that the received payment 12 or adjustment 21 fails to match the expected reimbursable amount in the receivable record.

As described above, the receivable manager 8 (FIG. 1) gathers data on charges 3 along with other data from the patient management system 5 and the contract management system 2 and creates the receivable view 9 for use with billing and collection activities. In the case of new charges 3 introduced into the system 1, the charges are pre-grouped by the component or unit sending the charge information. For example, the contract management system 2 presents charges 3 that are already grouped into contract management result sets 4, which include an expected reimbursement amount. If the contract management system 2 is a component of a larger sending system (not shown), then the present system 1 uses the results set 4 generated by the contract management component 2. If the sending unit forwards charges 3 without any accompanying reimbursement calculation, then the system 1 cannot and does not assume or request any grouping or categorization that would normally be included in a contract management result set 4.

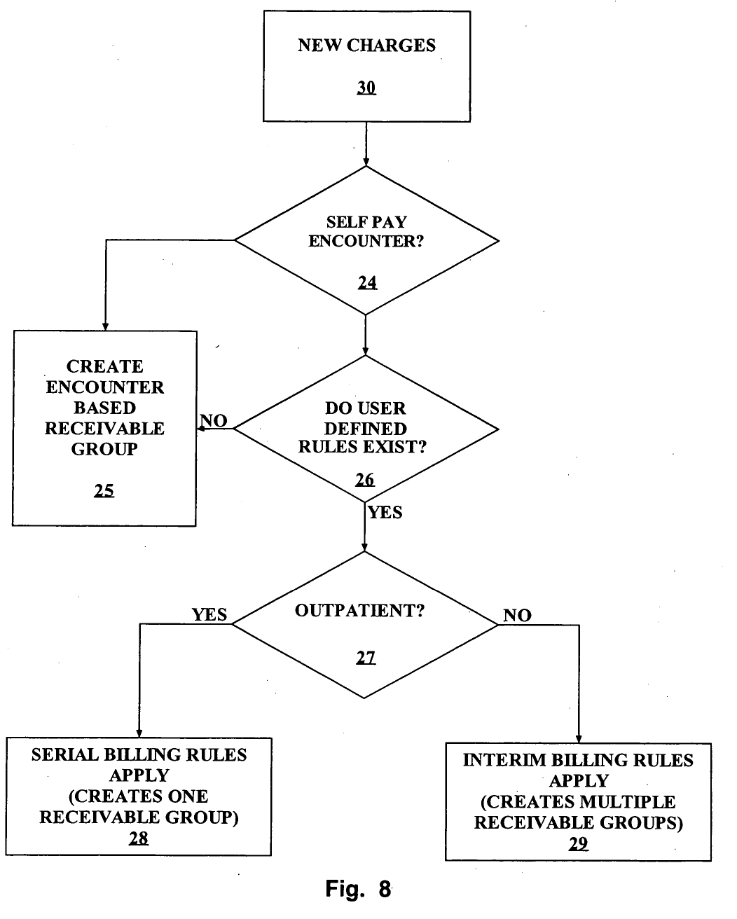

The default serial and interim billing rules 15 and 16 used by the system 1 (FIG. 1) can be understood by reference to FIG. 8. To determine when the serial billing receivable rules 15 and the interim billing receivable rules 16 apply, the system 1 receives data representing new charges 3 at step 30. At step 24, if the data indicates that the new charges 30 apply to a situation in which no payer 22 (FIG. 2) coverage exists under a policy 20, that is if only a guarantor 17 exists for these charges 3, at step 25 the system 1 automatically creates an encounter-based receivable group record 11 (FIG. 2). This also occurs if, at step 26, no user-defined billing rules are found to exist. If such rules do exist, at step 27 the system 1 determines if the charge data indicates that the charge 3 is related to an outpatient encounter 7. If so, user-defined serial billing rules are applied at step 28. In this case, data representing charges 3 related to multiple encounters are stored in a single receivable group record 11, as may be appropriate for monthly billing of recurring services. If the charges related to an inpatient encounter 7, at step 29 the system 1 creates multiple receivable group records 11, each related to a respectively different time period, for a single inpatient encounter, as may be appropriate for monthly billing of a long term care inpatient admission.

User defined rules may be varied according to factors such as the specific healthcare provider business office involved in the transaction, the identity of the payer 22 or other specific health plan administrator, the particular contract terms contained in the insurance policy 20, the type of clinical service performed during the encounter 7, and/or the specific party that served as the healthcare provider during the encounter 7. Each user defined rule includes data indicating, among other things, the length of the billing period, whether late charges are placed in a separate unbilled receivable group, and a category or label for the associated receivable group according to some scheme such as, for example, recurring or nonrecurring outpatient physical therapy.

The user defined rules also condition the system 1 to place data representing receivable records 10 associated with the individual charges 3 in specified receivable group records 11. The receivable records 10 are automatically created by the system 1 at the claim, claim line or charge level as required to match the remittance practices of the payer 22 and the preferences of the healthcare provider's business office according to the user defined rules. The system 1 creates receivable records 10, according to the definition of a specific claim 13 as set forth in a healthcare plan or policy 20, that correspond to the payments expected to be received from the payer 22. More specifically, the system 1 does not create a receivable record 10 at a lower level (where the claim level is the highest level and the charge level is the lowest level) than the lowest level specified by the contract management result set 4.

If certain charges 3 need to be grouped together in order to determine the expected reimbursement, the system 1 ensures that data representing those charges 3 are placed in the same receivable record 10. For example, if reimbursement is provided on a maximum payment-per-case basis, where the case may be defined according to an encounter, a time period, or other criteria, then the expected reimbursement for any specific charge 3 cannot be determined. In this situation, a group of charges 3 having a total under the maximum payment-per-case are reimbursed in full while a group of charges 3 having a total over the maximum payment-per-case are reimbursed to the maximum amount. Data representing such a group of charges 3 are stored in a single receivable record 10 in which the expected reimbursement may be calculated based on the maximum payment-per-case basis.

The system 1 also automatically stores data representing charges 3 that are the responsibility of a guarantor 17 within one receivable record 10. Data representing that receivable record 10 is stored in the receivable group record 11 associated with the guarantor 17.

If applicable patient management or contract management information changes after receivable records 10 and receivable group records 11 have been created, the receivable manager 8 automatically corrects the receivable records 10 and the receivable group records 11 upon notification of the change. Consequently, at any moment the data representing charges 3 residing within the receivable records 10 and the data representing receivable records 10 residing within the receivable group records 11 are based on current information. When new information is received, the system 1, without user intervention, first removes the data representing the affected charges 3 from their current receivable records 10 and data representing the corresponding receivable records 10 from their current receivable group records 11 and then reprocesses the removed charges 3 into proper receivable records 10 and receivable group records 11 based on the updated rules 14, 15 and 16.

As an example of the foregoing automatic self-correcting function, assume that in an outpatient encounter 7 (FIG. 1) a series of physical therapy sessions is prescribed for a patient. The clinical service data in the patient monitoring system regarding the outpatient encounter 7 is modified to include data indicating the prescribed physical therapy services. This change, in turn, triggers the automatic self-correction function, described above, in system 1. The serial billing rules 15 are applied in order to create a serial billing receivable group record 11 that includes data representing the receivable records 10 which, in turn, include data representing the physical therapy charges 3.

Upon notification of this change, the receivable manager 8 (FIG. 1) removes data representing charges 3 (FIG. 2) from any receivable records 10 and data representing those receivable records 10 from any receivable group records 11 which are affected by this change. The receivable manager 8 then stores data representing the removed charge data 3 and the new physical therapy charges 3 into appropriate receivable records 10 and data representing those receivable records 10 into appropriate receivable group records 11, creating and populating new receivable records 10 and/or receivable group records 11 as necessary. In addition, if any payments 12 and/or adjustments 21 have already been posted to the original receivable records 10, thus adjusting the balance amount data stored in those records, the system 1 automatically reallocates those payments 12 and/or adjustments 21 to the appropriate new receivable records 10. The system 1 maintains a history of the original receivable records 10 and receivable group records 11. If the original receivable records 10 have already been invoiced, a payment 12 may arrive for that invoice. Reference to the history allows such a payment 12 to be linked to the original receivable record 10. The system 1 may then automatically posts such payments 12 to the appropriate new receivable record 10 without any user intervention.

If new charges 3 (FIG. 2) are received by the system 1 (FIG. 1) which are related to an interim or serial billed receivable group 11 after that interim or serial billed receivable group record has already been invoiced to the payer 22, then an option is available to indicate whether the payer 22 permits the late charge 3 to be associated with the previously invoiced claim 13 and a corrected claim 13 sent to the payer 22, or requires data representing the late charge to be included in a new claim 13. According to the option selected, the receivable manager 8 (FIG. 1) makes an automatic determination as to the proper disposition of a late charge 3 without user intervention.

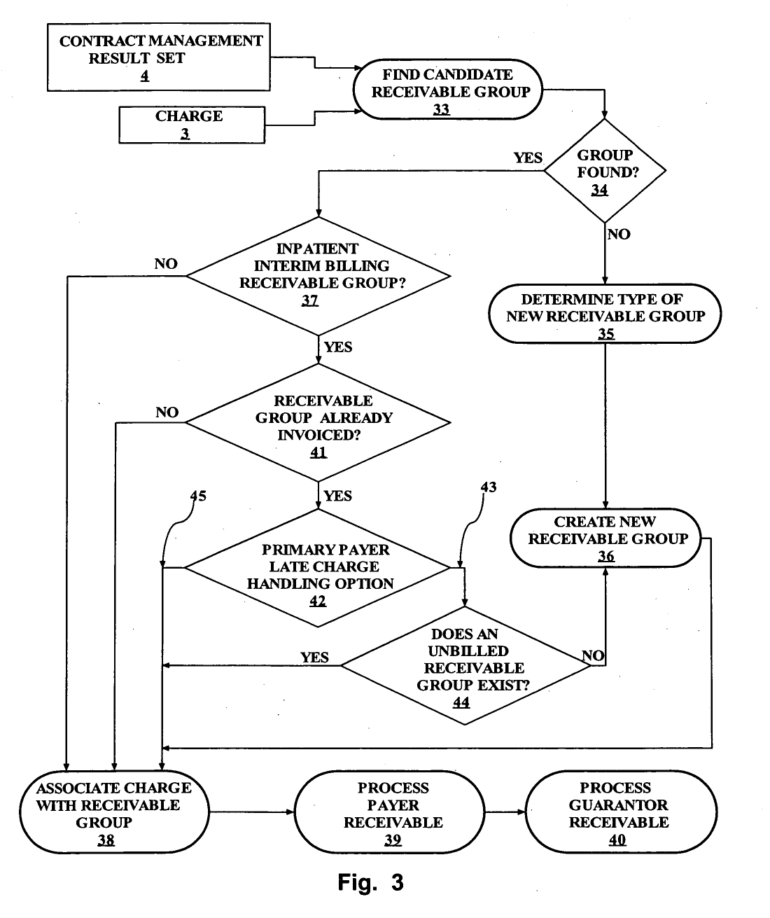

Referring to FIG. 3, the processing of new charges 3 by the system 1 can be understood. The contract management result set 4 and/or the new charge data 3 are processed at step 33, to specify a receivable group record 11 which should contain the data representing the new charge 3, a process described in more detail below. At step 34, the existing receivable group records 11 are searched to determine if the receivable group record 11 which was identified in step 33 as the one which should contain the new charge data 3 already exists. The failure to locate such a receivable group record 11 causes the charge data 3 to be forwarded to step 35, which determines, before a new receivable group is created, if the new receivable group is of the type which contains data representing inpatient interim billed receivable records 10, outpatient serial billed receivable records 10, or encounter-based receivable records 10. The determination of the receivable group type is based on an evaluation of the inpatient interim rules 16 (FIG. 1) for inpatient receivables and the outpatient serial rules 15 for outpatient receivables. At step 36 the new receivable group record 11 is created, and at step 38 data representing the new charge 3 is associated with that receivable group record 11. In step 39 a receivable record 10 for the payer 22, containing data representing the portion of the charge 3 allocated to the payer 22, is generated, and in step 40 a receivable record 10 for the guarantor 17, containing data representing the portion of the charge 3 allocated to the guarantor 17, is generated.

If step 34 determines that the receivable group record 11 which should contain the data representing the new charge 3 (as identified in step 33) already exists, step 37 determines if the existing receivable group record 11 is of the type intended for inpatient interim billing. If not, step 38 immediately associates the new charge 3 with the previously identified existing receivable group record 11 and generates the payer 22 receivable record 10 in step 39 and the guarantor 17 receivable record 10 in step 40, as described above. If so, step 41 determines if the identified receivable group record 11 has already been invoiced. If not, the new charge 3 is immediately associated with the previously identified existing receivable group record 11 and the associated receivable records 10 are generated (steps 38, 39, 40), as described above. If billing has already occurred for the identified receivable group record 11, the new charge 3 is a late charge. Step 42 determines what to do with the late charge 3. Option 43 is to assign the late charge 3 to a unbilled receivable group record 11. At step 44 such a unbilled receiving group record 11 is searched for. If such a receivable group record 11 exists, the late charge 3 is associated with that receivable group record 11 and the associated receivable records 10 are generated (steps 38, 39, 40), as described above. If not, a new receivable group record 11 is created in step 36 and the late charge 3 associated with the newly created receivable group record 11 in step 38. The associated receivable records 10 are then generated (steps 39, 40), as described above. Option 45 associates the late charge 3 to the previously billed receivable group record 11 in step 38. The associated receivable records 10 are then generated (steps 39, 40), as described above. A corrected invoice is then generated and sent to the payer 22, as described above.

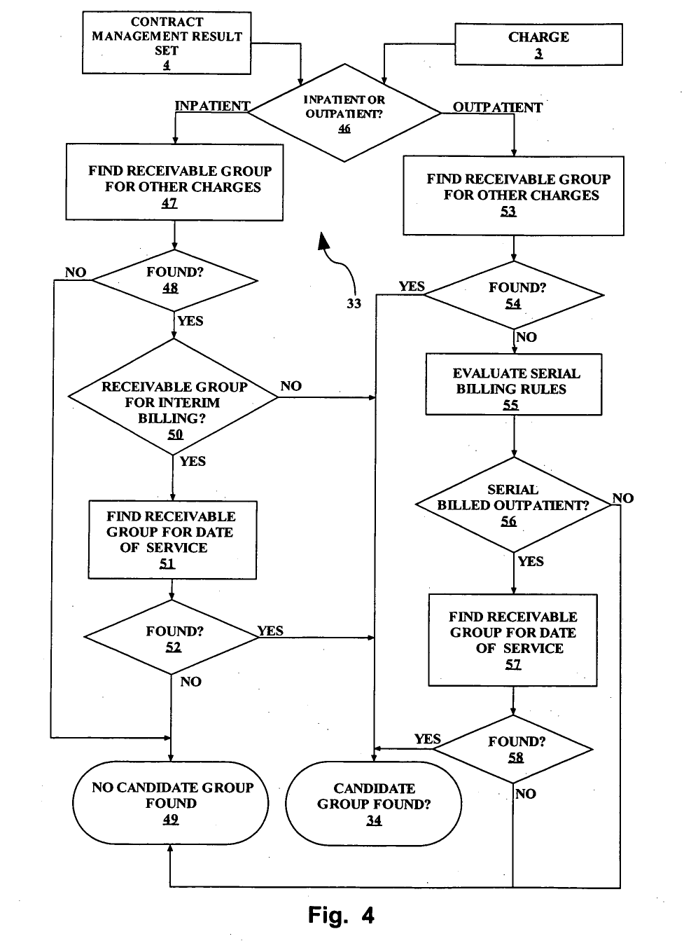

Referring to FIG. 4, the process of step 33 in FIG. 3, which specifies a receivable group record 11 which should contain data representing a new charge 3, is described in more detail. Step 46 receives the data representing the contract management result set 4 and/or charge 3, and determines if the new charge 3 is associated with an inpatient or an outpatient. If the charge 3 is associated with an inpatient, step 47 searches for an inpatient receivable group record 11 containing data representing other related charges within the contract management result set 4. At step 48, if no such receivable group record 11 is found the search is terminated at step 49 with an indication that no receivable group record 11 has been found which should contain data representing the new charge 3. If an appropriate inpatient receivable group record 11 is found, step 50 determines if the potential receivable group record 11 is intended for interim, periodic billing. If not, then that receivable group record 11 may include data representing charges from any date, and the search is terminated with an indication that an candidate receivable group record 11 has been found. In this case, data representing the candidate receivable group record 11 and the data representing the new charge 3 is forwarded to step 34 (FIG. 3).

If the potential receivable group record 11 is of the interim billing type, it may include charges from a predetermined date interval. Step 51 determines if the predetermined date interval of the potential receivable group record 11 includes the date on which the service associated with the new charge 3 was performed. If not, then that charge may not be associated with that receivable group record 11, and the search is terminated at step 49 with an indication that no candidate receivable group record 11 has been found. If the time period of the potential receiving group record 11 includes the date of the new charge 3, then the search terminates with an indication that a candidate receivable group record 11 has been found. Step 52 forwards data representing that candidate receivable group record 11 and the charge 3 to step 34 (FIG. 3) for further processing. More than one potential interim billing receivable group record 11 may be searched in the manner illustrated in steps 51 and 52 to determine if the date of the charge 3 lies within the date interval of any of the potential interim billing receivable group records 11.

If the charge 3 is associated with an outpatient, step 53 searches for an existing outpatient receivable group record 11 containing data representing other charges from the contract management result set 4. If such a receivable group record 11 is found at step 54, the search is terminated with an indication that a candidate receivable group record 11 has been found. Data identifying the candidate receivable group record 11 and the new charge 3 is forwarded to step 34 (FIG. 3).

As described above, a plurality of outpatient encounters to be repeated over a relatively long date interval (e.g. physical therapy sessions) may be billed to the payer 22 (FIG. 2) in a single bill for that date interval, or in successive bills for encounters continuing over successive date intervals. Data representing such charges 3 are collected into a single serial billed receivable group record 11 for each such date interval. The payer 22 serial billing rules 15 (FIG. 1) are used to determine whether charges 3 may be serially billed. If no receivable group record 11 is located in steps 53 and 54, then step 55 evaluates the data representing the new charge 3 according to the outpatient serial billing rules 15. If the charge 3 data indicates that the charge is not attributable to a serial billed outpatient encounter, the search is terminated at step 49 with in indication that no candidate receivable group record 11 has been found. If the charge data 3 indicates that the charge is associated with a serial billed outpatient encounter, step 57 searches for a serial billed receivable group record 11 for the date interval that includes the date on which the service associated with the new charge 3 was performed, and which also satisfies any other limitation(s) imposed by the serial billing rules 15. If no such receivable group record 11 is found at step 58, the search is terminated at step 49 with an indication that no candidate receivable group record 11 has been found. If such a receivable group record 11 is found, the search is terminated with an indication that a candidate receivable group record 11 has been found. Data identifying the candidate receivable group record 11 and the new charge 3 is forwarded to step 34 (FIG. 3). As described above, more than one potential serial billing receivable group record 11 may be searched in the manner illustrated in steps 57 and 58 to determine if the date of the charge 3 lies within the date interval of any of the potential serial billing receivable group records 11.

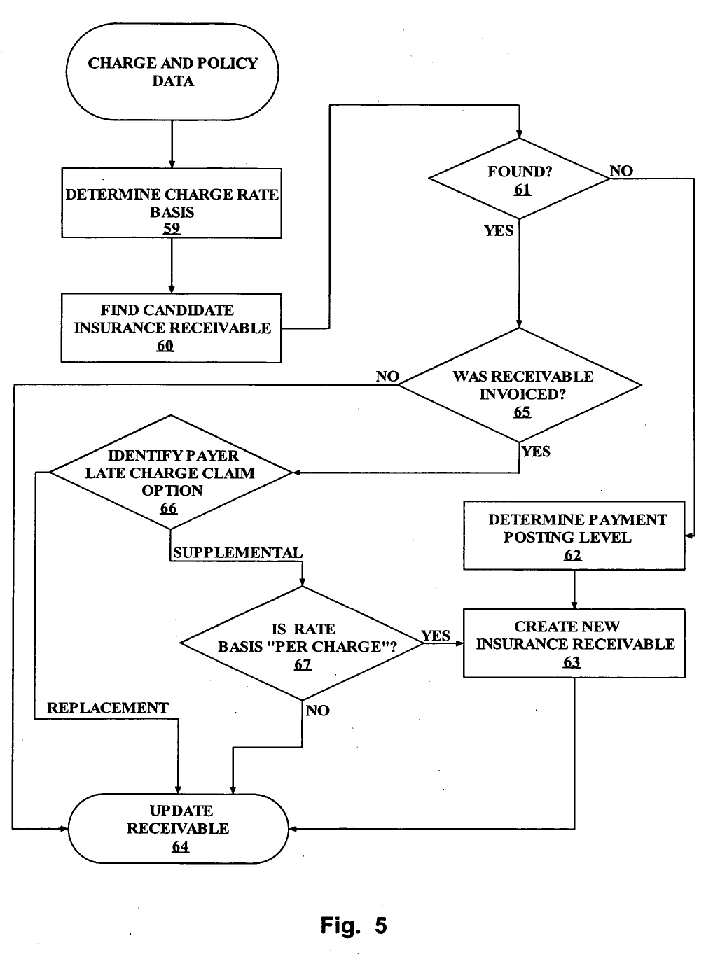

As described above with respect to step 39 of FIG. 3, when a new charge 3 is received, a receivable record 10 (FIG. 2) for the payer 22, containing data representing the portion of the charge 3 allocated to the payer 22, is generated and data representing that receivable record 10 is stored in an appropriate receivable group record 11. FIG. 5 describes in more detail the processing of a receivable record 10 associated with a payer 22 when, for example, the payer 22 is an insurance company. The proportion of the charge 3 which is allocated to the payer 22 (e.g. 70%) is termed the charge rate basis. The charge rate basis is determined by the policy contract 20 (FIG. 2) between the patient 6 and the insurance company 22. As described above, data 14 (FIG. 1) representing provisions of the insurance policy is maintained in the system 1.

Referring to FIG. 5, data representing the charge 3 and insurance policy data 14 (FIG. 1) is analyzed in step 59, to determine the charge rate basis of the new charge 3. At step 60 an existing candidate receivable record 10 having the same charge rate basis and the expected payment level (claim, claim line, charge) as that of the charge 3 is sought. If none is found at step 61, the expected payment level of a new receivable record 10, as specified by the data 14 (FIG. 1) representing the health plan's claim definitions, is determined at step 62. Once the expected payment level is determined, a new insurance receivable record 10 including data specifying that payment level is created at step 63. That receivable record 10 is updated at step 64 by adding data representing the amount of the new charge 3 expected to be paid by the payer 22 insurance company.

If step 61 locates one or more existing candidate payer 22 receivable records 10 including data representing prior charges 3 with the same charge rate basis and expected payment level as the newly received charge 3, step 65 determines if the charges included in that receivable record 10 were previously invoiced. If not, the candidate receivable record 10 is updated at step 64 by adding data representing the amount of the new charge 3 expected to be paid by the payer 22 insurance company. If this receivable record 10 has already been invoiced, the new charge 3 is considered a late charge. Step 66 determines how the payer 22 wishes late charges to be invoiced based on the option specified in the data 14 (FIG. 1) representing the health plan's claim definition. As described above, the options are: (a) invoice the late charges on a new separate, supplemental claim; or (b) invoice the late charges on a replacement claim generated by adding the late charge to the previously invoiced claim. If the data 14 (FIG. 1) representing the payer 22 rules indicates that late charges are added to the previously invoiced claim to form a replacement claim, the existing receivable record 10 which contains the data representing the previously invoiced charges 3 is updated at step 64 by adding data representing the amount of the new charge 3 expected to be paid by the payer 22 insurance company.

As described above, most healthcare procedures are reimbursed on a “per charge” basis. That is, each such procedure may be reimbursed separately by the payer 22. However, some healthcare procedures are reimbursed on a “maximum amount” basis. That is, no more than a maximum amount is reimbursed by the payer 22 for one or more encounters of this type. If in step 66 the data 14 (FIG. 1) representing the payer 22 rules indicate that late charges are billed to the payer 22 in a new supplemental claim, step 67 determines if the late charge 3 is for a procedure reimbursed on a “per charge” basis. If not, the new charge 3 is a “maximum amount” basis charge, and the receivable record 10 which contains the data representing the other charges for this healthcare procedure is updated at step 64 by adding data representing the amount of the late charge 3 expected to be paid by the payer 22 insurance company. If, in step 67, the late charge 3 is for a procedure reimbursed on a “per charge” basis, a new insurance receivable record 10 is created at step 63. The newly created receivable record 10 is updated at step 64 by adding data representing the amount of the late charge 3 expected to be paid by the payer 22 insurance company to that receivable record 10.

As described above, when changes occur in the rules 14 (FIG. 1) for apportioning charges 3 among payers 22 and guarantors 17 (e.g. because of changes to the insurance contract), or when changes in the medical treatment of the patient 7 require changes in method of billing the payer 22 (e.g. because of a change from outpatient to inpatient), or if an error occurs in the previous grouping of charges 3 into receivable records 10 and receivable group records 22, it is possible that data representing charges 3 which has previously been stored in receivable records 10 and associated receivable group records 11 may need to be reallocated. The receivable manager 8 (FIG. 1) receives a message identifying such an event. These changes are manifest as changes in the contract management sets 4 (FIG. 2). As described above, the illustrated embodiment provides an auto-correction function to perform these reallocations without requiring manual input from system 1 users.

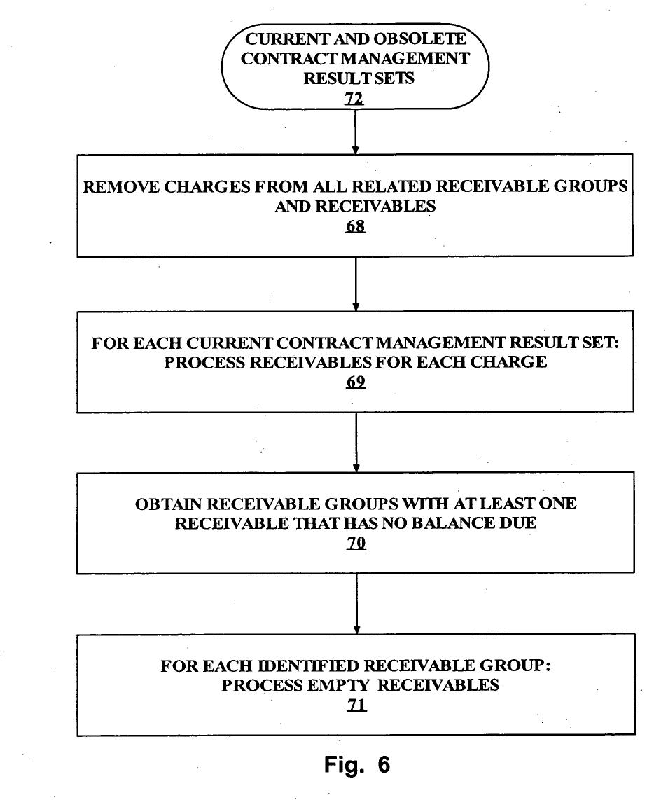

Referring now to FIG. 6, the auto-correct feature is described in more detail. Step 72 receives one or more current and obsolete contract management result sets 4 existing as a consequence of the changes, e.g. in insurance contract or patient care, described above. At step 68, data representing charges 3 which are related to an obsolete contract management set 4 are removed from related receivable records 10 and the associated receivable group records 11. This occurs for each such obsolete contract management result set 4. At step 69, the charge data 3 removed in step 68 is stored in appropriate receivable records 10, and data representing the newly updated receivable records 10 is stored in appropriate receivable group records 11, in accordance with the current contract management result sets 4. If a single contract management result set 4 has been recalculated as the result of a charge data modification, steps 68 and 69 consider that single result set 4 as both current and obsolete.

Receivable group records 11 containing data representing at least one receivable record 10 with no balance due (termed an empty receivable) are identified at step 70. Such a receivable record 10 includes data representing charges 3, and data representing payments 12 (FIG. 2) and adjustments 21. For each receivable group 11 identified in step 70, the empty receivables are processed at step 71 by reallocating any data representing a payment 12 or adjustment 21 previously posted to the old receivable record 10 to the corresponding new receivable record 10 in the new receivable group record 11.

The system 1 (FIG. 1) is applicable to any healthcare field that requires management of receivables. In addition to the healthcare enterprise market consisting of the hospital and the physician, the present invention is applicable to other fields such as home healthcare, dental care and psychiatric care. The present system can be made a part of an overall patient access and revenue management system designed to streamline patient registration while reducing errors by eliminating the need to manually group or categorize charges into the proper accounts. While the healthcare services provided have been explained by way of example to inpatients and outpatients, the services may be of any type and may be provided to any entity. The following glossary defines terms specific to the healthcare field and is included to aid in understanding the terminology describing the specific embodiments of the present invention.

Though described with reference to tracking charges and payments for provision of healthcare services, the system described above may be used to track charges and payments for services of any type provided to any entity. Such a system may be particularly applied to situations in which more than one entity is responsible for reimbursement for such charges

GLOSSARY

| Term | Definition |
|---|---|
| Charge | The dollar amount associated with a performed service. This |
| | amount can be manually entered, but is usually calculated based on |
| | rules in the service definition. |
| Claim | A demand for a sum of money due from a payer for one or more services |
| | rendered. The claim is a means of informing a payer |
| | which services were rendered, regardless of whether payment is |
| | expected. The claim includes one or more lines. |
| Claim Line | An individual reporting of a service rendered on a paper or |
| | electronic claim. |
| Clinical Service | A primary classification of care, such as laboratory, radiology or |
| | physical therapy. |
| Clinical System | A system for collecting core information about individuals relating |
| | to their care which allows ongoing useful clinical information to be |
| | recorded for use in direct patient care. |
| Contract | A grouping of charges for one or more encounters that are reimbursed |
| Management | together by the primary responsible party as a unit. |
| Result Set | |
| Contract | An information system which calculates expected reimbursement |
| Management | from payers based on contracts between the providers and the |
| System | payers. The contract states what coverage is provided for |
| | specific services, and what the patient obligations are in order to |
| | obtain that coverage. If the service is covered by the payer, |
| | contract management calculates the expected payment that the |
| | provider receives for providing the service along with the financial |
| | obligation of the patient. |
| Encounter | The meeting or contact between the patient and the healthcare |
| | provider for the purpose of obtaining healthcare services.. The |
| | range of encounters includes the admission to the hospital (even |
| | for a lengthy stay) or a phone call to a physician. Each visit (or |
| | telephone call) constitutes an encounter. The encounter includes |
| | the smallest interaction that has meaning to the healthcare |
| | provider. Some other terms often used as synonyms for |
| | encounter include case, visit, or stay. |
| Guarantor | The person or organization who promises or guarantees to pay |
| | for that portion of the patient's health related services that are not |
| | covered by the patient's health (insurance) plan. Guarantors |
| | typically include the patient, relatives, friends, an employer, a |
| | court or a trust. |
| Health Plan | A specific, salable product “offering” that includes a set of Plan |
| | health service benefits offered directly to the public or via |
| | sponsors to the employees or members of the sponsoring |
| | organization. There are many varieties of health plans such as |
| | indemnity, managed care and preferred provider organizations. |
| Interim Billing | The practice of submitting insurance claims to an insurer on a |
| | periodic basis while the patient is still receiving care as an |
| | inpatient. A final bill is submitted after the patient is discharged. |
| Patient | A person who has received services from a healthcare provider. |
| Patient | An information system used to control and monitor the entrance |
| Management | and exit of patients into and out of healthcare provider systems. |
| | Basic demographic, clinical and insurance information is |
| | collected in order to provide clinical services and receive financial |
| | payment. |
| Payer | An organization (or person) that pays for or underwrites coverage |
| | for healthcare expenses. A payer may be the government |
| | (Medicare), a nonprofit organization (Blue Cross/Blue Shield), a |
| | commercial insurance company, or some other organization, |
| | person, or entity. |
| Payment Variance | A difference between an expected payment for a billed service(s) |
| | and the payment received for that service(s). |
| Policy | A contractual arrangement stating that a Payer grants the |
| | benefits of a given Health Plan to the contract holder (or |
| | subscriber) and his or her beneficiaries. A Policy can also be |
| | considered a specific instance of a Health Plan. |
| Provider | A hospital or other healthcare institution or healthcare |
| | professional that provides healthcare services to patients. A |
| | provider may include one hospital, an individual, a group, |
| | organization or a government entity. |
| Receivable | A receivable is the smallest unit of debt for which the healthcare provider |
| | can expect payment and is used as a basis for |
| | calculating payment discrepancies. A receivable is associated |
| | with one receivable group. There are three types or levels of |
| | insurance receivables, namely the claim level, the claim line |
| | level, and the charge level. This categorization reflects how the |
| | payer remits and how the provider wishes to post the remittance. |
| | A receivable is specific to a responsible party. There may be |
| | multiple receivables within the same receivable group for each |
| | involved health plan. There is a single guarantor receivable for |
| | each guarantor involved. |
| Receivable Group | A collection of charges that are bundled together in order to |
| | satisfy payer billing requirements. The charges in a receivable |
| | group are assembled to form receivables. Thus, a receivable |
| | group is also a collection of receivables. |
| Reimbursement | The monetary compensation that a healthcare provider receives |
| | from a payer as consideration for providing services to patients. |
| | The reimbursement includes both estimated (expected) amounts |
| | and actual (collected) amounts. |
| Responsible Party | Any person or organization obligated to pay at least some of the charge |
| | resulting from an encounter. This term includes both |
| | payers and guarantors. |
| Serial Billing | The practice of submitting outpatient insurance claims for |
| | repetitive services that are performed during many encounters over an |
| | extended period of time. |

What is claimed is:

1. A system for grouping records of charges associated with provision of healthcare to a patient to support payment monitoring, comprising:
an acquisition processor for acquiring data related to charges for at least one encounter of a particular patient with a healthcare provider organization;
a source of rules for use in processing acquired charge data; and
a data processor using said acquired charge related data for creating a record grouping charges for provision of services associated with said at least one encounter and indicating an expected reimbursable amount value for said grouped charges, said charges being grouped using said rules to provide a reimbursable amount value expected from a payer organization.

2. A system according to claim 1, wherein said data processor groups charges expected to be reimbursed by said payer organization in a single payment remittance received by said healthcare provider organization, said charges being grouped based on at least one of, (a) a single individual charge comprises a group, (b) charges are grouped together in a claim to be submitted to a payer organization and (c) charges are grouped together as an item among a plurality of items in a claim to be submitted to a payer organization.

3. A system according to claim 1, further comprising a payment monitor for monitoring payments received for provision of services to patients by comparing said expected reimbursable amount in said created record with an amount identified in a received payment remittance.

4. A system according to claim 3, wherein in response to said comparison, said payment monitor generates an indication identifying at least one of, (a) said expected reimbursable amount in said created record matches an amount identified in a received payment remittance and (b) said expected reimbursable amount in said created record fails to match an amount identified in received payment remittances and action is required.

5. A system according to claim 1, wherein said data processor reallocates a charge in said created record to a different second created record in response to a received message identifying an event.

6. A system according to claim 5, wherein said identified event comprises at least one of, (a) a change in said rules used in processing acquired charge data and (b) an error in grouping said charges for provision of services in said created record.

7. A system according to claim 1, wherein said data processor creates said record by grouping charges in response to date of charge accrual and payer organization rules.

8. A system according to claim 7, wherein said payer organization rules comprise at least one of, (a) rules provided by a payer organization and (b) derived rules substituting for payer organization rules.

9. A system according to claim 1, wherein said data processor creates said record by grouping charges in response to payer organization rules comprising at least one of, (a) group together charges accruing within a first predetermined time period for multiple encounters of said particular patient with said healthcare provider organization, (b) group together charges accruing within a second predetermined time period for a single encounter of said particular patient with said healthcare provider organization, said single encounter having a duration comprising a plurality of said second predetermined time periods, (c) group together charges accruing in response to a single encounter of said particular patient with said healthcare provider organization, and (d) group together charges accruing in response to multiple encounters of said particular patient with said healthcare provider organization.

10. A system according to claim 9, wherein said first predetermined time period and said second predetermined period comprise at least one of, (i) a day, (ii) a week, (iii) a month, (iv) multiple months and (v) a payer organization defined period.

11. A system according to claim 1, wherein:
said particular patient comprises a plurality of related patients;
said acquisition processor acquires data related to charges for said at least one encounter of said plurality of related patients, and
said data processor uses said acquired charge related data for creating a record grouping charges for provision of services to said plurality of related patients.

12. A system for monitoring payment for provision of healthcare to a patient, comprising:
an acquisition processor for acquiring data related to charges for at least one encounter of a particular patient with a healthcare provider organization;
a data processor using said acquired charge related data for creating a record grouping charges for provision of services associated with said at least one encounter and indicating an expected reimbursable amount for said grouped charges, said charges being grouped in response to date of charge accrual and predetermined rules to provide a reimbursable amount value expected from a payer organization; and
a payment monitor for monitoring payments received for provision of services to patients by comparing said expected reimbursable amount in said created record with an amount identified in a received payment remittance.

13. A system according to claim 12, wherein said data processor groups charges expected to be reimbursed by said payer organization in a single payment remittance received by said healthcare provider organization, said charges being grouped based on at least one of, (a) a single individual charge comprises a group, (b) charges are grouped together in a claim to be submitted to a payer organization and (c) charges are grouped together as an item among a plurality of items in a claim to be submitted to a payer organization.

14. A system according to claim 12, wherein said data processor creates said record by grouping charges in response to payer organization rules comprising at least one of, (a) group together charges accruing within a first predetermined time period for multiple encounters of said particular patient with said healthcare provider organization, (b) group together charges accruing within a second predetermined time period for a single encounter of said particular patient with said healthcare provider organization, said single encounter having a duration comprising a plurality of said second predetermined time periods, (c) group together charges accruing in response to a single encounter of said particular patient with said healthcare provider organization, and (d) group together charges accruing in response to multiple encounters of said particular patient with said healthcare provider organization.

15. A system according to claim 12, wherein:
said acquisition processor acquires data related to charges for a plurality of encounters of a particular patient with a plurality of healthcare provider organizations, and
said data processor uses said acquired charge related data for creating a record grouping charges for provision of services associated with said plurality of encounters and indicates an expected reimbursable amount for said grouped charges by an individual healthcare provider organization of said plurality of healthcare provider organizations.

16. A system according to claim 12, wherein:
said acquisition processor acquires data related to charges for at least one patient encounter of a particular patient with a healthcare provider organization, and
said data processor uses said acquired charge related data for creating records grouping charges by responsible entity comprising at least one of, (a) an insurance company and (b) a guarantor.

17. A method for grouping records of charges associated with provision of healthcare to a patient to support payment monitoring, comprising the activities of:
acquiring data related to charges for at least one encounter of a particular patient with a healthcare provider organization;
applying rules for grouping said charges to provide a reimbursable amount value expected from a payer organization, using said acquired charge related data; and
creating a record grouping charges for provision of services associated with said at least one encounter and indicating said expected reimbursable amount value for said grouped charges.

18. A system according to claim 17, comprising a computer readable storage medium incorporating computer processor readable instruction for performing the activities of claim 17.

19. A system for grouping records of charges associated with provision of services to an entity to support reimbursement monitoring, comprising:
an acquisition processor for acquiring data related to charges for services provided to the entity;
a source of rules for use in processing the acquired charge data; and
a data processor, coupled to the acquisition processor and rules source, for grouping the charges using the rules to provide a reimbursable amount value and creating a record containing data representing the grouped charges and the reimbursable amount value.

20. A method for monitoring payment for provision of healthcare to a patient, comprising the activities of:
acquiring data related to charges for at least one encounter of a particular patient with a healthcare provider organization;
generating a record grouping charges for provision of services associated with said at least one encounter and indicating an expected reimbursable amount for said grouped charges, said charges being grouped in response to date of charge accrual and predetermined rules to provide a reimbursable amount value expected from a payer organization using said acquired charge related data; and
monitoring payments received for provision of services to patients by comparing said expected reimbursable amount in said created record with an amount identified in a received payment remittance.

21. A method for grouping records of charges associated with provision of services to an entity to support reimbursement monitoring, comprising the activities of:
acquiring data related to charges for services provided to the entity;
applying rules to the acquired charge data for grouping the charges to provide a reimbursable amount value; and
creating a record containing data representing the grouped charges and the expected reimbursable amount value.
